(19) United States
(12) Patent Application Publication
(10) Pub. No.: US 2015/0109340 A1
(43) Pub. Date: Apr. 23, 2015

(54) METHOD FOR DEPICTING SAFETY-CRITICAL DATA VIA A DISPLAY UNIT, DISPLAY UNIT

(71) Applicant: Cassidian Airborne Solutions GmbH, Bremen (DE)

(72) Inventors: Norbert Scherm, Bremen (DE); Christian Behrens, Bremen (DE); Torsten Frerichs, Hude (DE); Sven Heithecker, Bremen (DE)

(21) Appl. No.: 14/398,747

(22) PCT Filed: Apr. 15, 2013
(86) PCT No.: PCT/EP2013/057757

§ 371 Date: Nov. 4, 2014

(30) Foreign Application Priority Data
May 4, 2012 (DE) 10 2012 207 439.2

(51) Int. Cl. G06T 11/60

(52) U.S. Cl. CPC G06T 11/60; G09G 2340/12; G09G 2358/00
USPC 345/634

(57) ABSTRACT

A method for depicting data on the display of a modular display unit is provided. The data to be depicted comprises safety-critical data portions and non-safety-critical data portions data stream and depicted on the display via a graphical to the invention, a safety component of the display unit generates the safety-critical data portions based on safety-critical signals which are supplied to the display unit, while a background component of the display unit generates the non-safety-critical data portions in the form of a background screen. The safety-critical data portions are put on the display over said background screen in that a multiplexer converts the graphical data stream for display between the safety component and the background component, wherein, the specific regions, graphical content of the background screen changes and safety-critical graphical content is introduced and depicted on the display.

### BACKGROUND

Embodiments of the invention relate to a method for depicting data on the display of a modular display unit, wherein the data to be displayed comprises safety-critical data portions and non-safety-critical data portions and wherein the data are supplied to the display via a graphical data stream and are depicted on the display.

Embodiments of the invention furthermore relate to an associated display unit.

The depicting of safety-critical data on multi-functional displays can be problematic since the complete chain involving the generating, processing and converting of the data to video data, along with the actual display requires a developmental process that matches the critical nature of the data. In particular, this is true for the development of expensive human-machine-interfaces on the basis of status windows, as well as their graphics creation. In the process, safety-critical graphics controllers as well as potentially heterogeneous control units must generally be developed.

For the software and hardware development in the aviation field, for example, standards such as the DO-254 (Design Assurance Guidance for Airborne Electronic Hardware) and the DO-178 (Software Considerations in Airborne Systems and Equipment Certification) must currently be taken into consideration. At the same time, a software or hardware can more or less endanger the safety of the airplane, depending on its function, so that a distinction can be made between safety-critical data and less safety-critical or non-safety-critical data which are arranged correspondingly in different categories. In dependence thereon, different development methods are authorized and/or specified, resulting in different requirements for documentation and proof, wherein this process is involved and tied to high costs for safety-critical data.

### SUMMARY

An embodiment of the invention may make available a method for depicting safety-critical data on a display, for which the development process is simplified and the required degree of documentation and proof is kept as low as possible.

Embodiments of the invention may provide an associated display unit which meets these requirements.

The method according to embodiment of the invention is used to depict data on the display of a modular display unit, wherein the data to be depicted comprise safety-critical data portions and non-safety-critical data portions. The data are supplied to the display via a graphical data stream and are then depicted on the display. In the process, a safety component of the display unit is intended to generate the safety-critical data portions based on safety-critical signals that are supplied to the display unit while a background component of the display unit generates the non-safety-critical data portions in the form of a background image or screen. The safety-critical data portions on the display are then placed over this background image in that a multiplexer switches the graphical data stream supplied to the display between the safety component and the background component. As a result, the graphic content of the background image is changed in specific regions and safety-critical graphic content are introduced and depicted on the display.

The safety-critical data portions are data that are critical to a system which includes the display unit, meaning that if these data portions contain errors and/or in case of a failure of the data portions, the safety of the associated system would be compromised. The non-safety-critical data portions, on the other hand, are of little or no importance to the safety of an associated system. Whether this is the case and to which category the data portions need to be assigned depends not only on the technical parameters of systems, but also on the guidelines and standards to be used. The categorization of data portions can thus change even if the system remains the same if the guidelines change.

The approach according to embodiments of the invention thus moves the requirement of depicting safety-critical graphic content to a display unit. On the basis of safety-critical signals, a display unit of this type consequently generates display-internal the corresponding safety-critical graphic content in the form of text or symbols to be depicted. The content is applied in the form of an “overlay” to a background image that is safety-technically not relevant by purposely changing the image data stream of the background image in the regions of the safety-critical data.

As a result of this measure, a display unit according to embodiments of the invention, for example, comprises features that correspond at the point in time of application to a DAL-B Application in aviation and/or a SIL-3 Application according to IEC 61508. An identical perspective can lead according to the MIL-STD-882 to a categorization according to level D or higher.

Moving the safety-critical generating of graphical data to the display unit can furthermore simplify the design of potentially heterogeneous control devices and the depiction of respectively relevant status data. In particular, the development of safety-critical graphics controllers can thus be avoided. Complex image content and information can also be depicted in this way, and the approach according to the invention permits a modular configuration and a high reuse quota for the use in changed safety-critical applications.

In principle, embodiments of the invention is particularly suitable for cockpit uses in all aircraft such as airplanes or rotary-wing aircraft, but also for ground stations for unmanned aircraft (drones). However, the invention is not limited to the use in the field of aviation, but could also be utilized for other types of vehicles, such as ships and/or for the fire control.

The method according to embodiments of the invention can thus be embodied such that the background component generates the background image based on background pages that are stored in a background page memory, wherein the background page memory is a component of the modular display unit. Alternatively or in addition, the background component can also generate the background image based on non-safety-critical signals which are supplied externally to the modular display unit.

When generating the safety-critical data portions using the safety component, symbols can furthermore be used which are called up from a symbol memory of the safety component while positions are called up from a position memory for determining the position of said symbols.

According to a preferred embodiment of the invention, the safety-critical data portions are generated at least twice redundant within an architecture of the safety component, and a voting unit of the safety component realizes a selection between the redundant generated safety-critical data portions before feeding these into the graphical data stream. It is advantageous, however, to use a three times redundant architecture, for example to realize a 2-out-of-3 voting. As a result, the critical nature of the data portions generated in the safety component can be taken into account.

Embodiments of the invention furthermore comprise a corresponding modular display unit which includes at least one safety component and one background component, wherein the safety component is embodied to generate the safety-critical data portions based on safety-critical signals which were supplied to the display unit while the background component is embodied to generate the non-safety-critical data portions in the form of a background image. The display unit furthermore comprises at least one multiplexer which, for the display, is designed to switch the graphical data stream between the data portions of the safety component and those of the background component.

The method can be realized with the aid of this display unit.

The safety component for generating the safety-critical data portions correspondingly comprises an at least twice redundant architecture and a voting unit for selecting and feeding redundantly generated data portions into the graphical data stream. The safety component can furthermore comprise at least one symbol memory and one position memory, wherein symbols for safety-critical data portions are stored in the symbol memory while associated positions for the symbols are stored in the position memory. A set of pre-assembled graphical contents, consisting of text and symbols, can be stored in a memory of the display unit and can subsequently be called up. Since the memory content is generic, proof and documentation need only be established once. This type of library can then be used for different applications.

In addition, the modular display unit of one exemplary embodiment of the invention comprises a background page memory which is connected to the background component, wherein background pages are stored in the background page memory for generating the background image. Alternatively or in addition, the display unit can be provided with at least one input for supplying the background component with non-safety-critical signals which can also be used for generating the background image. Thus, the background pages to be used for generating the background image can include not only permanently stored pages, but also variably insertable pages.

### DESCRIPTION OF THE DRAWING

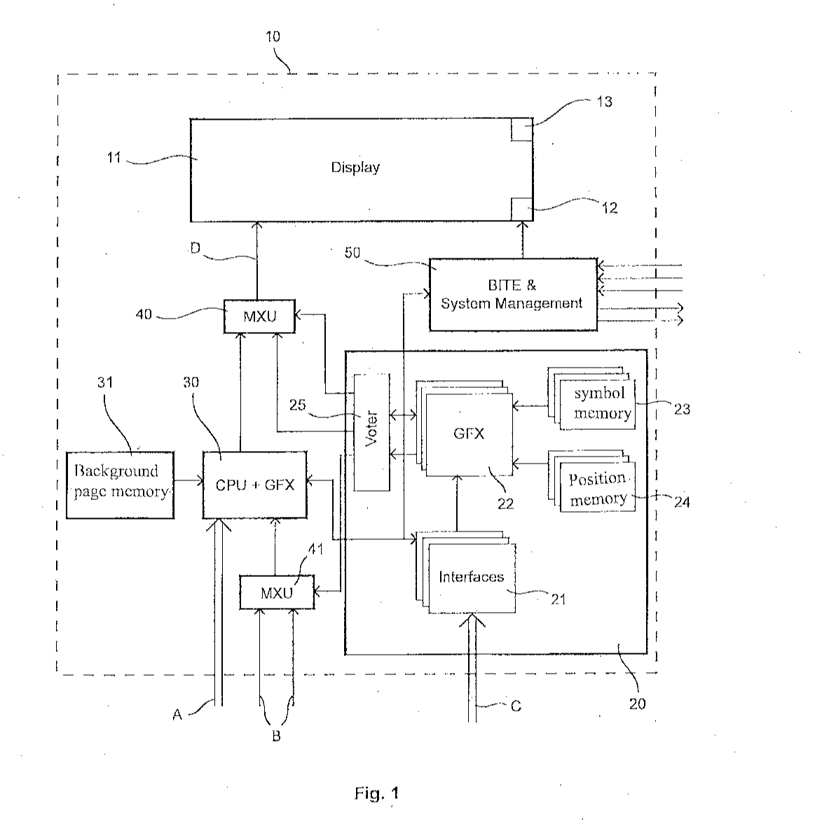

Further advantages, special features and useful modifications of the invention can be found in the dependent claims and the following representation of the preferred exemplary embodiment, shown in FIG. 1.

### DETAILED DESCRIPTION

FIG. 1 illustrates an exemplary embodiment of the display unit 10 according to the invention, which is used to explain the method according to the invention for displaying data. The display unit 10 (shown with dashed lines) comprises at least one display 11, one safety component 20, one background component 30 and a first multiplexer 40 (MXU1). The display 11 is a series produced LC (liquid crystal) display, for example, which can also be referred to as COTS LC display (COTS=commercial-off-the shelf/components-off-the-shelf). Cost savings in particular can be achieved as a result of the series production, which does not require special adaptations ex factory. Since COTS-LC displays of this type are categorized, for example, as “complex COTS” according to the DO-254 Guidelines valid on the filing date, a monitoring of the respective displays is necessary. In that case, a pixel monitoring 12 can be used for which the color information in one corner of the display 11 is purposely selected and is monitored with the aid of photo diodes. With the exemplary embodiment shown in FIG. 1, for example, this is realized in the lower right corner of the display 11. According to a different exemplary embodiment of the invention, a pixel signal is conducted via optical fiber into the casing for the display unit 10 and is evaluated therein. As a result, the electro-magnetic compatibility (EMC performance) of the display unit 10 can be improved.

An activity indicator 13 with cyclical symbol change can furthermore also be shown on the LC display 11, by means of which the freezing of the display can be indicated. For example, the activity indicator 13 normally shows a constant symbol change but a symbol change no longer takes place as soon as the display is frozen, which is obvious to the operator. The LC display furthermore preferably moves to black, as soon as the pixel clock, the line sync or the frame sync signal are missing, wherein this is also indicated to the operator. Instead of this type of evaluation of the display 11 activity by the operator, however, an automated evaluation can also occur in the same way as for the pixel monitoring 12.

The pixel monitoring 12 in one corner of the display 11, as well as the activity indicator 13, can be created with a safety-critical data path. In the exemplary embodiment shown in FIG. 1, these functions as well as the human-machine-interface (HMI=human-machine-interface) are tied to a system-management function 50. Shown via the HMI are commands such as a change in the image page, a change in the video source, the adaptation of the display brightness, and the test image functions, as well as the corresponding status indicators. The HMI functions in this case are accessible via external interfaces (e.g. CAN BUS), wherein these functions can also comprise an additional BITE module. A BITE module is a built-in testing device (BITE=built-in test equipment) which allows testing and monitoring the correct mode of operation for a system and, if applicable, to react automatically to problems that occur. The BITE module thus tests and monitors the display 11. The BITE module can be implemented in the form of a programmable hardware and can transfer the BITE data of the bus interface to a maintenance system outside of the display unit 10.

The LC display 11 is connected via a graphical data stream D to the safety component 20 and the background component 30, wherein the display 11 is informed via this graphical data stream which data must be shown on the display.

For this, a first multiplexer 40 switches the graphical data stream D between a safety-critical data portion, generated by the safety component 20, and a non-safety-critical data portion, generated by the background component 30, wherein individual regions of a background image can be manipulated purposely through the correct activation of the multiplier 40, so as to place the safety-critical data portions over the non-safety-critical background image and depict these jointly on the display 11.

The background image is generated by the background component 30 which processes exclusively non-safety-critical data, wherein the background image can comprise masks, texts and video data, as well as other non-safety-relevant data portions. The background component 30 essentially consists of a CPU/GFX (graphic processing unit/graphical effects) combination which is preferably realized as COTS assembly of hardware and software components. The non-safety-critical background images used can be stored, for example, in a background page memory 31 which belongs to the display unit 10 and can take the form of a read-only memory (ROM). However, the background pages can also be transmitted externally to the display unit 10, for example via DVI signal (DVI=digital visual interface). The non-safety-critical background images can thus also be supplemented by adding non-safety-critical data A via additional bus data or discrete signals. Signals B can furthermore be taken over from external video sources and can be processed further. These signals from external video sources are then preferably multiplexed with the aid of a second multiplexer 41 (MXU2) before being supplied to the background component 30.

The safety component 20 is based completely on a 2oo3 architecture (2 out of 3 architecture), for example, and is implemented in programmable hardware (e.g. FGPA, PLD)¹. The triple redundancy of the individual sub-components and a voting component make it possible in this case that the error or failure of a sub-component within the voting component is overruled by the other two sub-components. Thus, all three sub-components must fail before the complete system fails. Since it is to be expected that the sub-components fail independent of each other and the aforementioned does not happen, the probability of a total system failure is very low. ¹FGPA=field-programmable gate arrayPLD=programmable logic device

The 2oo3 architecture is shown schematically in FIG. 1 with the hardware components, taking at least the form of three interfaces 21 that are shown one above the other, three GFX components 22 and a voting unit (voter) 25. In this case, at least the interfaces 21 and the GFX component 22 should have triple redundancy, but additional components such as the memories 23 and 24 can also be embodied with triple redundancy. This variant is also shown in FIG. 1 with respectively three memories 23, 24, shown one above the other. The memories 23 are symbol memories with therein stored symbols for the depiction on the display 11, while the memories 24 are position memories in which the associated positions of the symbols are stored. The memories 23, 24 can be embodied as ROM memories, wherein the symbol and position ROM memories advantageously comprise an error and correction (ECC) or a parity code. The symbols to be displayed and the image positions are thus stored hard-coded in the memories, wherein the memory content is generic.

Safety-critical signals C are then accepted via the three interfaces 21, which can be realized via Ethernet/AFDX, ARINC, CAN, Flexray, discrete signals or a combination of these signal paths. Corresponding to the contiguous status data, the corresponding symbol position is respectively read out of the position memories 23 while the corresponding symbol is read out of the symbols memories 24. Subsequently, the symbol is inserted via GFX share at the corresponding position into the graphical data stream D by adjusting the multiplexer 40 and inserting the symbol or the symbols into the graphical data stream D.

Corresponding to the image positions as 2oo3 architecture, the multiplexer 40 in the process is read out of the position memory 24 by each of the safety-critical GFX shares 22 and is then evaluated via the voter 25. This represents the precise pixel image position of the safety-critical image shares, computed by the 2oo3 architecture, and delivers the switching signal for the multiplexer 40.

The case is similar for the multiplexer 41. In that case, the switching of several video inputs B is also computed from the interfaces C via the safety-critical (video) data path 20.

### LIST OF REFERENCE SIGNS

10 display unit

11 display, LC display

12 pixel monitoring

13 activity indicator

20 safety component

21 interface

22 GFX component

23 symbol memory

24 position memory

25 voting unit; voter

30 background component

31 background page memory

40 multiplexer for graphical data stream, MXU1

41 multiplexer for external video source data, MXU2

50 system-management-function, testing device, BITE module

A non-safety-critical supplementary signal

B external video source signal

C safety-critical signal

D graphical data stream

1. A method for depicting data on the display of a modular display unit, wherein the data to be depicted comprise safety-critical data portions and non-safety-critical data portions and wherein the data are supplied to the display via a graphical data stream and are depicted on the display, comprising:
generating with a safety component of the display unit the safety-critical data portions based on safety-critical signals which are supplied to the display unit, while generating the non-safety-critical data portions with a background component of the display unit in the form of a background image and placing the safety-critical data portion over this background image on the display by using a multiplexer that switches the graphical data stream for the display between the safety component and the background component, as a result of which graphic content of the background image is changed in specific regions and safety-critical graphic content is introduced and depicted on the displayer.

2. The method according to claim 1, wherein background component generates the background image based on background pages stored in a background page memory, wherein the background page memory-forms a component of the modular display unit.

3. The method according to claim 1, wherein the background component generates the background image based on non-safety-critical signals (A; B) which are supplied externally to the modular display unit.

4. The method according to claim 1, wherein when generating the safety-critical data portions with the safety component, symbols are used which are called up from a symbol memory of the safety components while positions are called up from a position memory for determining the positions of these symbols.

5. The method according to claim 1, wherein the safety-critical data portions are generated at least twice redundant within an architecture of the safety component and that a voting unit of the safety component realizes a voting between the redundantly generated safety-critical data portions prior to feeding it into the graphical data stream.

6. A modular display unit for depicting data on a display of the modular display unit, wherein the data to be depicted comprise safety-critical data portions and non-safety-critical data portions and wherein the display unit comprises means for feeding the data to the display via a graphical data stream and means for depicting the data on the display, wherein the display unit comprises at least one safety component and one background component, wherein the safety component is designed to generate the safety-critical data portions based on safety-critical signals which are supplied to the display unit while the background component is configured to generate the non-safety-critical data portions in the form of a background image, and that the display unit furthermore also comprises at least one multiplexer which is designed to switch the graphical data stream for the display between the data portions of the safety component and those of the background component.

7. The modular display unit according to claim 6, wherein for the generating of the safety-critical data portions, the safety component comprises an at least twice redundant architecture and a voting unites for selecting and feeding redundant-generated data portions into the graphical data stream.

8. The modular display unit according to claim 6, wherein the safety component comprises at least one symbol memory and one position memory, wherein symbols for safety-critical data portions are stored in the symbol memory while the positions associated with the symbols are stored in the position memory.

9. The modular display unit according to claim 6, wherein the unit comprises a background page memory which is connected to the background component wherein background pages for generating the background image are stored in the background page memory.

10. The modular display unit according to claim 6, wherein the unit is provided with at least one input for supplying the background component with non-safety-critical signals which can be used for generating the background page.
